(19) United States
(12) Patent Application Publication
(10) Pub. No.: US 2009/0225462 A1
(43) Pub. Date: Sep. 10, 2009

(54) MAGNETIC TAPE DEVICE

(76) Inventor: KENICHI OJIMA, Tokyo (JP)

Correspondence Address: NEC CORPORATION OF AMERICA, 6535 N. STATE HWY 161, IRVING, TX, 75039, US

(21) Appl. No.: 12/396,994

(22) Filed: Mar. 3, 2009

(30) Foreign Application Priority Data
Mar. 4, 2008 (JP) 2008-052764

(51) Int. Cl. G11B 27/36; G11B 5/78

(52) U.S. Cl. 360/31; 360/134; G9B/27.052; G9B/5.291

(57) ABSTRACT

The invention provides a magnetic tape device including a magnetic head; a drive unit; an abnormality detector for detecting an abnormality in operation of the magnetic tape; and a release unit for releasing the contact between the magnetic tape and the magnetic head when the abnormality detector detects any abnormality during the running of the magnetic tape.

This application is based upon and claims the benefit of priority from Japanese patent application No. 2008-052764, filed Mar. 4, 2008, the disclosure of which is incorporated herein in its entirety by reference.

### BACKGROUND OF THE INVENTION

1. Field of the Invention

The present invention relates to a magnetic tape device for recording and reproducing data on magnetic tape.

2. Background of the Invention

Magnetic tape devices employing magnetic tape as a storage medium have recently been developed as external storage devices for computers. When a magnetic tape device performs data recording or reproduction processing, magnetic tape runs in contact with a magnetic head. When the recording or reproduction processing is suspended, the magnetic tape remains in contact with the magnetic head. If the magnetic tape stays in this state for a prolonged time, the magnetic tape is possibly stuck on the magnetic head. Therefore, there are demands for countermeasures against this problem.

In order to improve the contact between magnetic tape and a magnetic head, an air escape groove may be provided in the surface of the magnetic head which comes into contact with the magnetic tape. However, the shape of this grove is possibly transferred to the magnetic tape to cause irregularity of the surface of the magnetic tape. This irregularity may result in an error in recording or reproducing data. Therefore, countermeasures against this problem are also demanded.

As one of countermeasures against these problems, there has been proposed a related art for preventing magnetic tape from being stuck on a magnetic head and preventing the shape of groove from being transferred to the magnetic tape. According to this related art, a gap is formed in a central portion of the magnetic head, and air is blown to the magnetic tape from this gap with the use of an air pump to thereby avoid the direct contact between the magnetic tape and the magnetic head.

Another related art is also proposed, according to which magnetic tape is caused to run in a reciprocating manner over a minute distance during the idle period in which the magnetic head is not performing recording or reproducing operation.

However, the former related art requires an air pump which is expensive and large in size, in order to avoid the direct contact between the magnetic tape and the magnetic head. Thus, this method has a problem that it is difficult to reduce the size and cost of the magnetic tape device.

In the latter related art, the magnetic tape runs in a reciprocating manner over a minute distance typically at predetermined intervals. Since these intervals are set to a fixed value regardless of temperature within the magnetic tape device, problems as follows are posed. Specifically, magnetic tape is more apt to stick to the magnetic head as the temperature becomes higher. If the intervals mentioned above are set to an unduly low value even though the temperature is low, the magnetic tape will be damaged by the reciprocating running. In contrast, if the intervals are set to a high value even though the temperature is high, the magnetic tape cannot be prevented from being stuck to the magnetic head.

In order to solve these problems: Japanese Laid-Open Patent Publication No. H08-96438 (Patent Document 1) proposes a magnetic tape device which is suitable for reducing the size and cost the device and is adapted to detect the temperature within the device for preventing magnetic tape from being stuck to the magnetic head, in a desirable manner.

### SUMMARY OF THE INVENTION

However, according to Patent Document 1, in order to desirably prevent the magnetic tape from being stuck to the magnetic head, the temperature within the magnetic tape device is detected by a temperature sensor arranged near the magnetic head within the magnetic tape device, and an operation to eliminate the sticking of the magnetic tape to the magnetic head is performed once the detected temperature exceeds a predetermined value.

The temperature sensor described above does not directly detect the temperature of the magnetic tape and the magnetic head, but detects the temperature in the vicinity of the magnetic head so that the operation to eliminate the sticking of the magnetic tape to the magnetic head is performed once the detected temperature exceeds a reference temperature at which the sticking of the magnetic tape to the magnetic head presumably occurs. Therefore, if the reference temperature is set too low, the operation to eliminate the sticking of the magnetic tape to the magnetic head is performed even though the magnetic tape is not stuck to the magnetic head, posing a problem that the operation to eliminate the sticking is performed too often. If the reference temperature is set too high, in contrast, it takes some time to commence the operation to eliminate the sticking of the magnetic tape to the magnetic head even though the magnetic tape is stuck to the magnetic head. In addition, the technique described in Patent Document 1 has a problem that the operation to eliminate the sticking of the magnetic tape to the magnetic head can be performed only during the idle period of the magnetic tape device in which the magnetic head is not performing the recording or reproducing operation.

Therefore, an exemplary object of the invention is to provide a magnetic tape device which is capable of quickly starting an operation to eliminate the sticking of magnetic tape to the magnetic head only when the sticking of the magnetic tape to the magnetic head is confirmed, and thus capable of eliminating the waste and inefficiency in the operation and reducing the load to the magnetic tape.

A magnetic tape device according to an exemplary aspect of the invention comprises a magnetic head for recording and reproducing data on and from magnetic tape; a drive unit for running the magnetic tape in contact with the magnetic head along with the data recording or reproducing operation of the magnetic head; an abnormality detector for detecting an abnormality in operation of the magnetic tape; and a release unit for releasing forcibly the contact between the magnetic tape and the magnetic head when any abnormality is detected by the abnormality detector while the magnetic tape is running.

The present invention provides an advantageous effect that the operation to eliminate the sticking of the magnetic tape to the magnetic head can be quickly performed only when the sticking of the magnetic tape to the magnetic head is confirmed.

### BRIEF DESCRIPTION OF THE DRAWINGS

FIG. 1 is a plan view of a principal portion of a magnetic tape device 1 according to an embodiment of the present invention;

FIG. 2 is a plan view showing a state in which the sticking of magnetic tape 7 to a magnetic head 2 has been eliminated;

FIG. 3A is a diagram showing a mechanism of a tape lifter 3;

FIG. 3B is a cross-sectional view taken along line 3B-3B of FIG. 3A;

FIG. 4 is a block diagram showing an example of a hardware configuration of the magnetic tape device 1; and

FIG. 5 is a flowchart showing processing to eliminate the sticking of the magnetic tape 7 to the magnetic head 2.

### EXEMPLARY EMBODIMENT

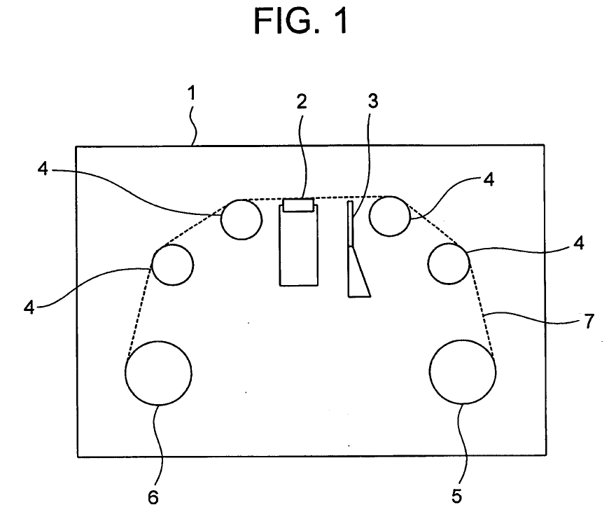

A most preferred exemplary embodiment will be described with reference to the accompanying drawings. FIG. 1 is a plan view illustrating a principal portion of a magnetic tape device according to an embodiment of the present invention. As shown in FIG. 1, the magnetic tape device 1 comprises a magnetic head 2, a tape lifter 3, a roller guide 4, a cartridge reel 5, a machine reel flange 6, and magnetic tape 7.

Next, description will be made of how the magnetic tape 7 is run within the magnetic tape device. In the state of the magnetic tape 7 as shown in FIG. 1, an end of the magnetic tape 7 stored on the cartridge reel 5 is in contact with the roller guide 4 and the magnetic head 2, and is connected to a certain part of the machine reel flange 6.

The cartridge reel 5 and the machine reel flange 6 are driven separately by a reel motor 8 (not shown in FIG. 1) which is an independent drive unit. Thus, the magnetic tape 7 can be run under a certain tension by driving the independent reel motor 8, so that data can be recorded on or reproduced from the magnetic tape 7 by means of the magnetic head 2.

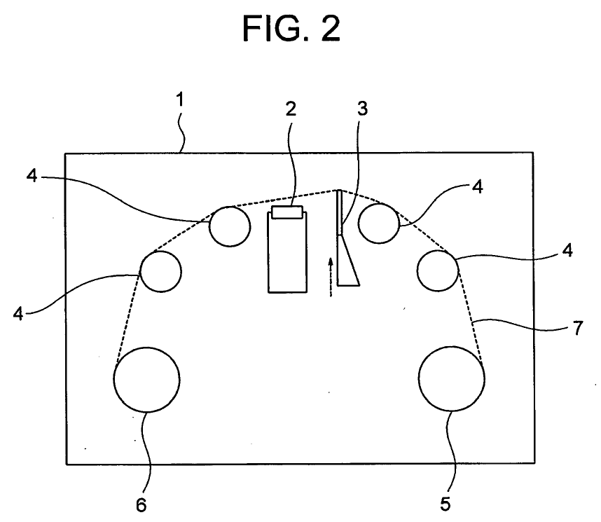

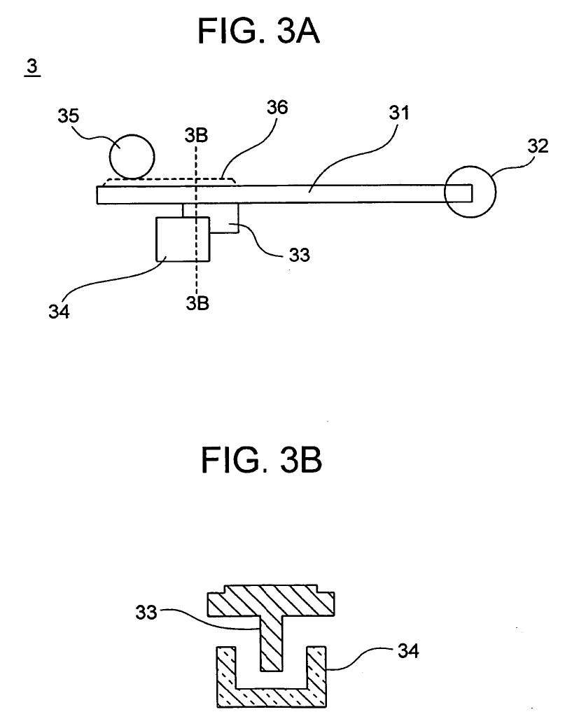

FIG. 2 shows the state in which when the magnetic tape 7 is stuck to the magnetic head 2, the sticking is eliminated by the tape lifter 3 functioning as a release unit. The tape lifter 3 is moved upward as viewed in FIG. 2 (in the direction indicated by the arrow in FIG. 2) to lift up the magnetic tape 7, whereby the sticking of the magnetic tape 7 to the magnetic head 2 is eliminated. Mechanism of the tape lifter 3 will be described later in detail with reference to FIGS. 3A and 3B.

FIGS. 3A and 3B are diagrams showing a mechanism of the tape lifter 3. When the magnetic tape 7 is stuck to the magnetic head 2, the tape lifter 3 is driven. More specifically, a motor 35 is driven to slide a rack 36 in a part of a lifter bar 31 by means of a pinion gear (not shown) provided on the motor 35, whereby the lifter bar 31 formed as a bar-like projection can be protruded. The tape lifter 3 comprises a flag 33 and a photo sensor 34 both attached to the lifter bar 3 in order to detect the position of the lifter bar 31 during its sliding movement. The detection of the flag 33 by the photo sensor 34 confirms that the lifter bar 31 has been protruded sufficiently so that the magnetic tape 7 is pushed up by the distal end 32 of the lifter bar 31 and the sticking of the magnetic tape 7 to the magnetic head 2 is eliminated.

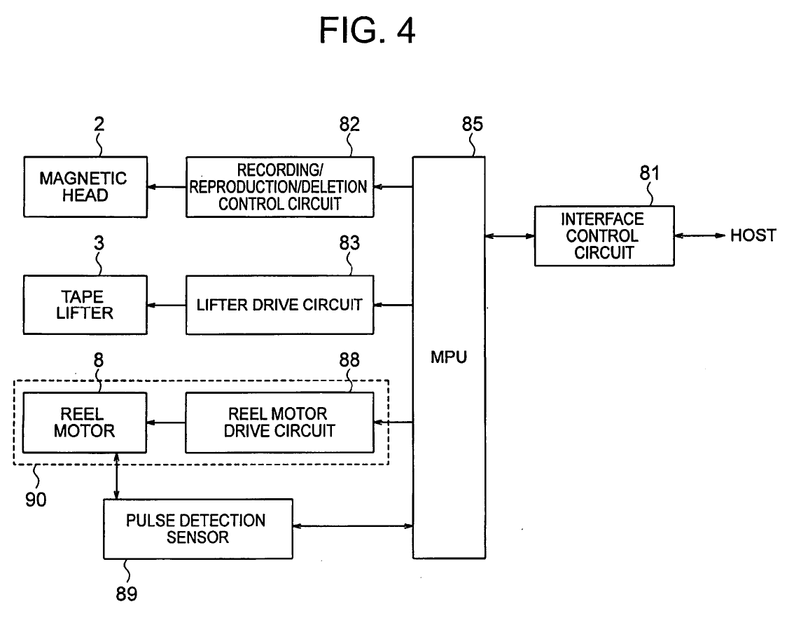

FIG. 4 is a block diagram showing a hardware configuration of the magnetic tape device 1. An MPU (microprocessor unit) 85 (an abnormally detector) is connected to a host computer serving as a host controller (not shown) via an interface control circuit 81.

Computation results obtained using various programs are supplied from the MPU 85, by means of electrical signals, to a recording/reproduction/deletion control circuit 82 for controlling the magnetic head 2, a lifter drive circuit 83 for driving the tape lifter 3, and a reel motor drive circuit 88 for driving the reel motor 8 (drive motor). In addition, a reel motor 8 and a reel motor drive circuit 88 is a component of drive unit 90.

A pulse detection sensor 89 serving detects a pulse generated by the reel motor 8 and transmits the detection result to the MPU 85.

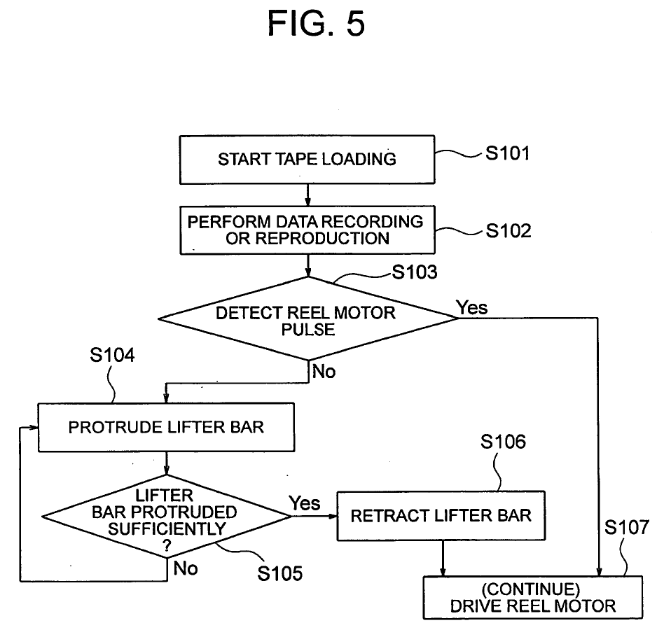

FIG. 5 is a flowchart showing a series of processing steps for eliminating the sticking of the magnetic tape 7 to the magnetic head 2.

First, in step S101, the MPU 85 transmit electrical signals instructing to drive the reel motor 8 to the reel motor drive circuit 88.

The MPU 85 also transmit electrical signals instructing to load magnetic tape 7 to the recording/reproduction/deletion control circuit 82, and loading of the magnetic tape 7 is commenced. In step S102, the magnetic tape 7 is tracked and then data is recorded on or reproduced from the magnetic tape 7.

In step S103, A pulse detection sensor 89 detects a pulse generated by the reel motor 8 and transmits the detection result to the MPU 85. The MPU 85 receives the detection result. If The MPU 85 detects any pulse generated by the reel motor 8, the processing proceeds to step S107 to continuously drive the reel motor 8 so that the recording and reproduction operation performed in step S102 is continued.

If The MPU 85 detects no pulse generated by the reel motor 8 in step S103, The MPU 85 determines that the reel motor 8 is not rotating even though an electrical signal instructing to drive the reel motor 8 is transmitted from the reel motor drive circuit 88, and the processing proceeds to step S104. The MPU 85 determines in this step the reel motor 8 is not rotating because the magnetic tape 7 is stuck to the magnetic head 2, hindering the rotation of the reel motor 8. The MPU 85 determines so based on the fact that no electrical signal instructing the stoppage of the reel motor 8 is supplied from the MPU 85 to the reel motor drive circuit 88.

In step S104, as described above with reference to FIGS. 3A and 3B, the MPU 85 transmit signals instructing to protrude the lifter bar 31 to the lifter drive circuit 83. The lifter bar 31 of the tape lifter 3 is protruded to eliminate the sticking of the magnetic tape 7 to the magnetic head 2. In step S105, the lifter drive circuit 83 determines whether or not the lifter bar 31 is protruded sufficiently. If it is determined that the lifter bar 31 is not protruded sufficiently, the motor 35 of the tape lifter 3 is driven to protrude the lifter bar 31 further. The determination of whether or not the lifter bar 31 is protruded sufficiently is performed by means of the flag 33 and the photo sensor 34 attached to the lifter bar 31, based on for example whether or not the lifter bar 31 has moved to a predetermined position, or whether or not the lifter bar 31 has moved by a predetermined amount. If it is determined that the lifter bar 31 is protruded sufficiently, it is presumed that the distal end 32 of the lifter bar 31 has lifted up the magnetic tape 7 to eliminate the sticking of the magnetic tape 7 to the magnetic head 2.

If it is determined in step S105 that the lifter bar 31 is protruded sufficiently, the lifter bar 31 is retracted in step S106, presuming that the sticking of the magnetic tape 7 to the magnetic head 2 has been successfully eliminated. Practically, the motor 35 which has been driven to protrude the lifter bar 31 is rotated reversely to bring the lifter bar 31 back to the original position. Upon completion of the retraction of the lifter bar 31, the processing proceeds to step S107, in which the data recording and reproduction operation performed in step S102 is resumed.

According to this embodiment of the invention as described above, if the pulse detection sensor 89 detects any abnormality during loading of the magnetic tape 7 (for example, if no pulse generated by the reel motor 8 is detected), the magnetic tape device 1 forcibly eliminates the sticking of the magnetic tape 7 to the magnetic head 2 by means of the tape lifter 3.

Therefore, the sticking of the magnetic tape 7 to the magnetic head 2 can be eliminated quickly only when it is confirmed that the magnetic tape 7 is stuck to the magnetic head 2.

While the invention has been particularly shown and described with reference to exemplary embodiment thereof, the invention is not limited to this embodiment. It will be understood by those of ordinary skill in the art that various changes in form and details may be made therein without departing from the spirit and scope of the present invention as defined by the claims.

What is claimed is:

1. A magnetic tape device comprising:
a magnetic head for recording and reproducing data on and from magnetic tape;
a drive unit for running the magnetic tape in contact with the magnetic head along with the data recording or reproducing operation of the magnetic head;
an abnormality detector for detecting an abnormality in operation of the magnetic tape; and
a release unit for releasing forcibly the contact between the magnetic tape and the magnetic head when any abnormality is detected by the abnormality detector while the magnetic tape is running.

2. The magnetic tape device as claimed in claim 1, wherein the drive unit comprises a drive motor for running the magnetic tape,
the abnormality detector detects that the drive motor has stopped in the state in which data is being recorded on or reproduced from the magnetic tape.

3. The magnetic tape device as claimed in claim 1, further comprising a pulse detection sensor which detects a pulse generated by the drive unit and transmits the detection result to the abnormality detector,
wherein the abnormality detector detects that no pulse is generated by a drive motor in the state in which data is being recorded on or reproduced from the magnetic tape.

4. The magnetic tape device as claimed in claim 2, wherein the release unit comprises a bar-shaped projection which shifts the magnetic tape in a vertical direction in response to detection of an abnormality by the abnormality detector.

5. A method of releasing contact between magnetic tape and a magnetic head, wherein the magnetic tape device as claimed in claim 1.
